(19) United States
(12) Patent Application Publication
(10) Pub. No.: US 2012/0098258 A1
(43) Pub. Date: Apr. 26, 2012

(54) APPARATUS FOR CONNECTING AND SEALING PIPELINES

(76) Inventors: Kamran Toudehfallah, Dubai (AE); Mohammad Toodehfallah, Dubai (AE); Alireza Tabrizi, Dubai (AE)

(21) Appl. No.: 13/031,267

(22) Filed: Feb. 21, 2011

Related U.S. Application Data
(60) Provisional application No. 61/405,516, filed on Oct. 21, 2010.

(51) Int. Cl. F16L 19/06

(52) U.S. Cl. 285/342

(57) ABSTRACT

The various embodiments herein provide an apparatus for sealing and connecting pipelines ends laid on the land surface and in under water. According to an embodiment herein, the connector is made of hardened steel comprising of tubular housing shell, a plurality of bolts located over the housing shell, a wedge, at least two pusher leg associated to the bottom of the wedge, at least two gasket on either side of the connector end, a gasket spacer, a seat ring, an anti extrusion ring and a gripping block wherein the plurality of bolts are fastened vertically over the housing shell applying pressure on the wedge. The wedge in turn pushes the pusher legs forcing aside the gasket spacer, the seat ring and the anti extrusion ring towards the gripping block to apply pressure on the gaskets, sealing the pipelines ends.

### CROSS-REFERENCE TO RELATED APPLICATIONS

This application claims the benefit of Provisional Application No. 61/405,516 filed Oct. 28, 2010.

### BACKGROUND

1. Technical field

The embodiments herein generally relates to pipelines and particularly to structural connectors for connecting pipelines. The embodiments herein more particularly relates to a sealing and gripping apparatus for connecting pipelines and for branching out pipelines in high pressure piping systems in onshore oil and gas pipelines, mining industries, power plants and also for repairing a damaged pipeline.

2. Description of the Related Art

Pipelines are basically used for transportation of fluid such as liquids and gases to two or more geographically separated stations. The liquids commonly include water, crude oil, petroleum or any chemically stable substance and gases include natural gas, petroleum gas etc. Semi liquid substances such as cement mixture, slurry, sewage mixture etc., are also transported through the pipelines using vacuum and air pressures.

The pipelines can be laid on the land surface buried under ground or laid under water. As the pipelines are manufactured using high grade steel and iron, the pipelines can be laid on any surface. The pipelines are laid down connecting different geographical points which are separated by few miles to thousands of miles. Further it is impossible to manufacture a single long pipeline connecting the two far off distant geographical locations.

Depending upon the internal liquid pressure, operating temperature and surface condition, the pipes are manufactured in small lengths varying in meters. These pipes are connected by a connector which is manufactured using a high grade steel and iron. The connectors connect two or more pipeline ends such that a vacuum lock is created in sealing the two pipeline ends.

The currently available pipeline connectors are bulky in size and are unable to open the pipeline joints during an operation for testing. The gaskets used in the connectors are exposed outside the connector sealing to provide a dangerous condition as the gasket gets eroded. The method of manufacture of the connector gripping system depends on the internal fluid or gaseous pressure. Thus the pipes are manufactured for a single pipeline size and single pressure rating. Further, the presence of one layer of gasket after the gripper block, the absence of test ports and the absence of horizontal nut sealing provides a need for the development of a new pipeline connector system.

Hence there is a need to provide a pipeline connector apparatus for sealing and gripping pipeline ends with a test port between the sealing gaskets. Also there is a need for a pipeline connector apparatus which provides vertical bolting for sealing the pipeline ends in vacuum pressure and for repairing the damaged pipeline structurally.

The abovementioned shortcomings, disadvantages and problems are addressed herein and which will be understood by reading and studying the following specification.

### OBJECTIVE OF THE EMBODIMENTS

The primary object of the embodiments herein is to provide a sealing and gripping apparatus for connecting pipeline ends.

Another object of the embodiments herein is to provide a sealing and gripping apparatus which can be opened during a pipeline operation for testing.

Yet another object of the embodiments herein is to provide a sealing and gripping apparatus which includes vertical bolting system for connecting two pipeline ends in an air tight condition.

Yet another object of the embodiments herein is to provide a sealing and gripping apparatus which includes a test port facility to test the sealing and gripping apparatus prior to pressurizing the pipeline.

Yet another object of the embodiments herein is to provide a sealing and gripping apparatus which provides a double ended sealing in sealing and gripping the pipeline ends

Yet another object of the embodiments herein is to provide a sealing and gripping apparatus which can be used for connecting two pipeline ends of variable pipeline size and pressure rating.

These and other objects and advantages of the embodiments herein will become readily apparent from the following detailed description taken in conjunction with the accompanying drawings.

### SUMMARY

The various embodiments herein provide an apparatus for connecting pipelines. The apparatus comprises a housing shell, a plurality of bolts located over the housing shell, a wedge associated to the bottom of the plurality of bolts, at least two pusher leg associated to the bottom of the wedge, at least two gasket, a gasket spacer, a seat ring, an anti extrusion ring, and a gripping block wherein the plurality of bolts are fastened vertically over the housing shell applying pressure on the wedge and the wedge in turn pushes the pusher legs aside forcing the gasket spacer, the seat ring and the anti extrusion ring towards the gripping block to apply pressure on the gaskets thereby sealing the pipelines ends.

According to one embodiment herein, the apparatus further comprises at least one of a flange, a round coupling, a half sleeve clamp and tee shape end connector adapted to be welded to one end of the housing shell and the plurality of bolts fastened vertically over the housing shell is varied to receive varying size pipeline ends on the other end of the housing shell. The gripping blocks comprises a plurality of gripping threads through an angular groove on a pipeline wall surface inside the housing shell wherein the plurality of gripping threads through the angular groove increases the friction with the pipeline wall surface inside the housing shell.

According to one embodiment herein, the seat rings are conical in shape and placed between the pusher leg and the gripping block. The seat rings are arranged in the housing shell to support the distribution of transferred energy towards the gripping block. The pusher leg is cone in shape and is placed between the wedge and the seat ring so that the application of pressure on the pusher leg compresses the gasket through the seat rings. Further the compression of the gasket provides a sealing and gripping effect to the pipeline ends. The pusher leg is made of forged grade steel and the gasket is made of at least one of an elastomer rubber and a polyurethane material. Also the gasket spacer and the anti extrusion ring are made up of a forged grade metal. The anti extrusion rings prevent the gaskets from extruding underneath the mating gasket spacer rings.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates a sectional side view of a pipeline sealing and gripping apparatus according to an embodiment herein.

FIG. 2 illustrates a front perspective view of the pipeline sealing and gripping apparatus according to an embodiment herein.

FIG. 3 illustrates a front perspective view of the pipeline sealing and gripping apparatus according to an embodiment herein.

FIG. 4 illustrates an exploded view of the of the pipeline sealing and gripping apparatus according to an embodiment of the present disclosure.

Although the specific features of the embodiments herein are shown in some drawings and not in others. This is done for convenience only as each feature may be combined with any or all of the other features in accordance with the embodiments herein.

### DETAILED DESCRIPTION OF THE EMBODIMENTS

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The various embodiments herein provide an apparatus for sealing and connecting pipelines ends laid on the land surface and in under water. According to an embodiment herein, the connector is made of hardened steel comprising of tubular housing shell, a plurality of bolts located over the housing shell, a wedge associated to the bottom of the plurality of bolts, at least two pusher leg associated to the bottom of the wedge, at least two gasket on either side of the connector end, a gasket spacer, a seat ring, an anti extrusion ring and a gripping block wherein the plurality of bolts are fastened vertically over the housing shell applying pressure on the wedge, the wedge in turn pushes the pusher legs aside forcing the gasket spacer, the seat ring and the anti extrusion ring towards the gripping block to apply pressure on the gaskets, sealing the pipelines ends.

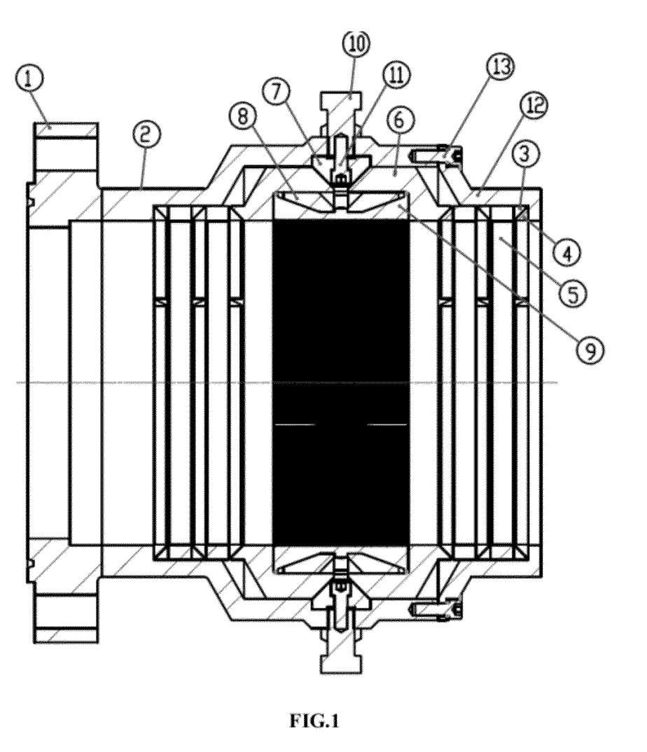

FIG. 1 illustrates a sectional side view of a pipeline sealing and gripping apparatus according to an embodiment of the present disclosure. With respect to FIG. 01, the pipeline sealing and gripping apparatus 101 has a circular housing shell 102 with flange 103 welded at one end. The flange 103 enables an integral connection between two pipe ends in a coupling. The apparatus provides a multi-sealing and gripping mechanism to provide reinforcement to the damaged leaking pipe through a clamp design and to provide reinforcement to the branched line through a split Tee design. The pipeline sealing and gripping apparatus 101 supports and connects various design pipeline ends thus enabling the pipeline sealing and gripping apparatus 101 in connecting pipeline ends with various sizes and pressure rating.

The housing shell 102 of the pipeline sealing and gripping apparatus 101 has sufficient space for gap adjustment between the two pipeline ends for connection. The Flange 103 will be adjusted with spool opposite flange 103 and seal with RF or RTJ intermediate gasket 106. In another embodiment, the pipeline sealing and gripping apparatus 101 can be used to connect the two pipeline ends by using the equivalent pipeline sealing and gripping apparatus without the flange 103 wherein the housing shell 102 and the flange 103 are manufactured from standard forged grade steel and machined to proper size and shape.

The housing shell 102 of the pipeline sealing and gripping apparatus 101 comprises two or more circular gaskets 106 made of elastomeric rubber and polyurethane or alike for sealing by compression through metal ring gasket spacer 104 and anti extrusion ring 105 is forced by steel pusher leg 107. Through the designed cavity front of the pusher leg 107, the pusher leg 107 will apply controlled and sufficient push to compress the gaskets 106 to generate sealing behavior by changing the size of gaskets 106. The anti extrusion ring 105 prevents the gaskets 106 from extruding underneath the gasket spacer rings 104 of the mating gaskets 106.

For gripping the pipeline wall, the vertical action bolts 111 push the main wedge 108 to push both the pusher legs 107 aside and hold to seal position of the two pipeline ends while the transfer of force moves down the seat rings 109 toward the gripping blocks 110. The gripping blocks 110 have gripping threads through angular grooves on the sides of the pipe wall to increase the friction with pipe wall surface. Also the cone shaped housing of the seat rings 109 support the distribution of the transferred energy towards the gripping surface thus maintaining the transferred energy in the designed channel and engaged with exposed step.

Each vertical action bolt 111 has a joint with an individual main wedge 108, a separate gripping block 110 and a locking system 112 in order to accommodate the possible oval-shape of the line while integrating through at least one piece pusher leg 107 and seat rings 109 to be able to balance push in the installation procedure and the reverse action in re-opening. The test port which is used for testing the pipelines can be adjusted between the two front sealing gaskets 106 to test the sealing prior to the installation. All other internal components of the housing shell 102 are heat treated and hardened to sufficient level and precisely machines for optimum size and surface. In one embodiment, the end door 113 is bolted by lock washer bolts 114 to the main region of the components which can also be threaded or clamp jointed.

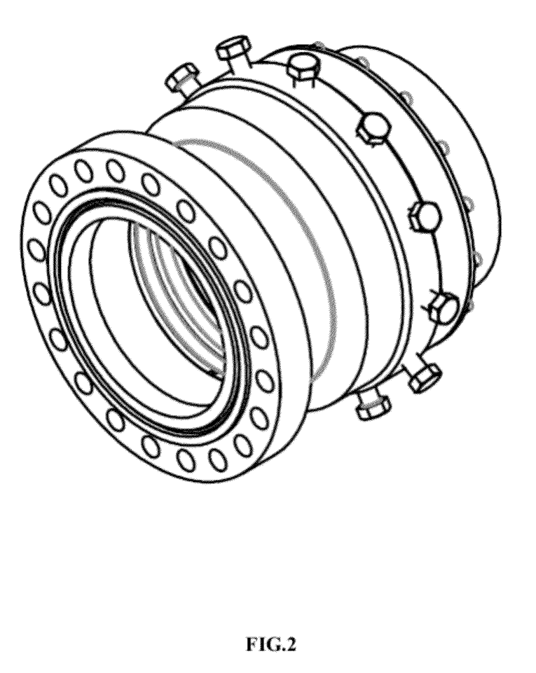

FIG. 2 illustrates a front perspective view of the pipeline sealing and gripping apparatus according to an embodiment of the present disclosure. With respect to FIG. 2, the pipeline sealing and gripping apparatus 101 has a circular housing shell 102 over which the vertical action bolts 111 are mounted. The housing shell 102 and vertical action bolts 111 are manufactured of high grade steel such that the housing shell 102 and vertical action bolts 111 are adapted to be used in tough land surfaces and under water surfaces. The internal part of the housing shell 102 uses multiple layer of varying size gaskets 106. The multiple layers of varying size gaskets 106 are made of round elastomer rubber and polyurethane or alike. The multiple layers of varying size gaskets 106 are separated by the anti extrusion rings 105. The anti extrusion rings 105 are manufactured of high grade steel and is used for separating the varying size gaskets 106. The pipeline sealing and gripping apparatus 101 includes a flange 103 at one end of the pipeline sealing and gripping apparatus 101 connector. The flange 103 has a plurality of cavities 201 on the edge of the flange 103 which allows other flange end connectors to connect and bolted through the cavity 201.

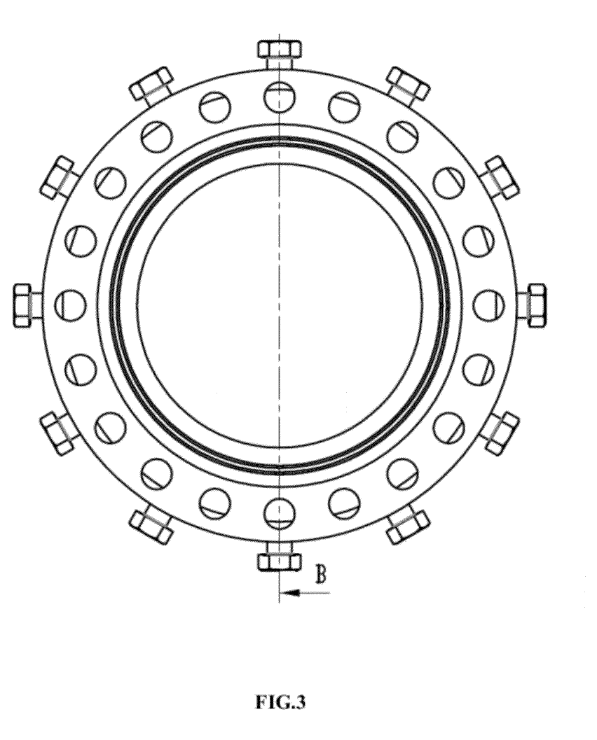

FIG. 3 illustrates a front perspective view of the pipeline sealing and gripping apparatus according to an embodiment of the present disclosure. With respect to FIG. 3, the pipeline sealing and gripping apparatus 101 has a circular housing shell 102 with flange 103 welded at one end. The pipeline sealing and gripping apparatus 101 has a circular housing shell 102 over which vertical action bolts 111 are mounted. The housing shell 102 and vertical action bolts 111 are manufactured of high grade steel such that the housing shell 102 and vertical action bolts 111 are adaptable to be used in tough land surfaces and under water surfaces.

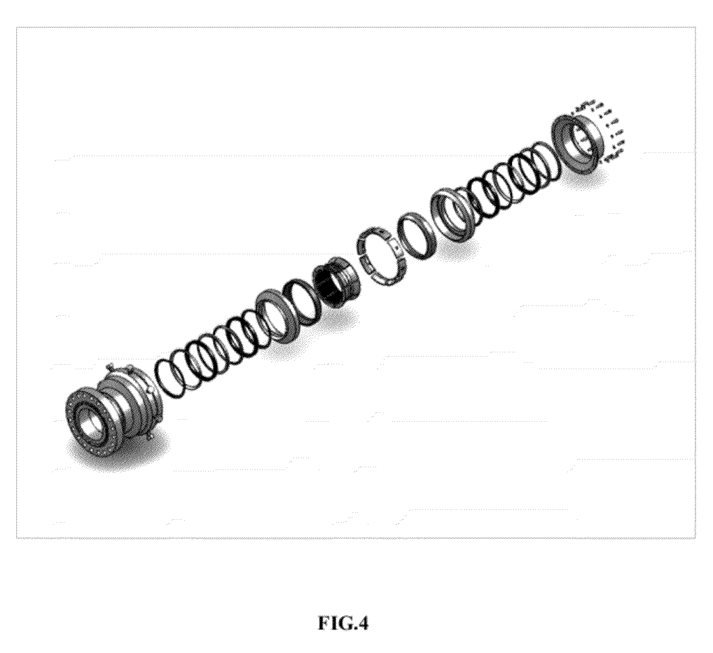

FIG. 4 illustrates an exploded view of the of the pipeline sealing and gripping apparatus according to an embodiment of the present disclosure. With respect to FIG. 4, the pipeline sealing and gripping apparatus 101 has a circular housing shell 102 with flange 103 welded at one end. The housing shell 102 of the pipeline sealing and gripping apparatus 101 has sufficient space for gap adjustment between the two pipeline ends for connection. The Flange 103 will be adjusted with spool opposite flange 103 and seal with RF or RTJ intermediate gasket 106. In another embodiment, the pipeline sealing and gripping apparatus 101 can be used to connect the two pipeline ends by using the equivalent pipeline sealing and gripping apparatus without the flange 103 wherein the housing shell 102 and the flange 103 are manufactured from standard forged grade steel and machined to proper size and shape.

For gripping the pipeline wall, the vertical action bolts 111 will push the main wedge 108 to push both the pusher legs 107 aside and hold to seal position of the two pipeline ends while the transfer of force moves down the seat rings 109 toward the gripping blocks 110. The gripping blocks 110 have gripping threads through angular grooves on the sides of the pipe wall to increase the friction with pipe wall surface. Each vertical action bolts 111 has a joint with an individual main wedge 108, a separate gripping block 110 and a locking system 112 in order to accommodate the possible oval-shape of the line while integrating through at least one piece pusher leg 107 and seat rings 109 to be able to balance push in the installation procedure and the reverse action in re-opening. The test port which is used for testing the pipelines can be adjusted between the two front sealing gaskets 106 to test the sealing prior to the installation. All other internal components of the housing shell 102 are heat treated and hardened to sufficient level and precisely machined for optimum size and surface. In one embodiment, the end door 113 is bolted by lock washer bolts 114 to the main region of the components which can also be threaded or clamp jointed.

According to one embodiment herein, a sealing and gripping device is used with or without joint flange to couple the pipe ends together, or used in two half sleeve to repair the pipe damage structurally. This mechanism is also applied to a split Tee fitting to branch the line without welding. This method is also used in offshore, top side and onshore oil and gas pipeline as well as risers connections, also in other high pressure piping systems like mining industries, power plants, etc

This design provides several advantages compare to similar products in the market, while reducing time and cost of installation and minimizing the risks involves in maintenance operation and down time of the line.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the claims.

It is also to be understood that the following claims are intended to cover all of the generic and specific features of the embodiments described herein and all the statements of the scope of the embodiments, which as a matter of language might be said to fall there between.

What is claimed is:

1. An apparatus for connecting pipelines, the apparatus comprising:
a housing shell;
a plurality of bolts located over the housing shell;
a wedge;
at least two pusher legs mounted at a bottom of the wedge;
at least two gaskets;
a gasket spacer;
a seat ring;
an anti extrusion ring; and
a gripping block, wherein the plurality of bolts are fastened vertically over the housing shell to apply pressure on the wedge and the wedge in turn pushes the pusher legs aside forcing the gasket spacer, the seat ring and the anti extrusion ring towards the gripping block to apply a pressure on the gaskets thereby sealing ends of the pipelines.

2. The apparatus according to claim 1, further comprises at least one of a flange, a round coupling, a half sleeve clamp and tee shaped end connector adapted to be welded to one end of the housing shell.

3. The apparatus according to claim 1, wherein the plurality of bolts fastened vertically over the housing shell is varied to receive ends of pipeline with varying sizes on another end of the housing shell.

4. The apparatus according to claim 1, wherein the gripping blocks comprises a plurality of gripping threads through an angular groove on a pipeline wall surface inside the housing shell.

5. The apparatus according to claim 4, wherein the plurality of gripping threads through the angular groove increases the friction with the pipeline wall surface inside the housing shell.

6. The apparatus according to claim 1, wherein the seat ring is conical in shape and placed between the pusher leg and the gripping block.

7. The apparatus according to claim 1, wherein the seat ring is arranged in the housing shell to support the distribution of transferred energy towards the gripping block.

8. The apparatus according to claim 1, wherein the pusher leg is conical in shape and is placed between the wedge and the seat ring.

9. The apparatus according to claim 1, wherein the application of pressure on the pusher leg compresses the gasket through the seat rings.

10. The apparatus according to claim 9 wherein the compression of the gasket provides a sealing and gripping effect to the pipeline ends.

11. The apparatus according to claim 1, wherein the pusher leg is made of forged grade steel.

12. The apparatus according to claim 1, wherein the gasket is made of at least one of an elastomeric rubber and a polyurethane material.

13. The apparatus according to claim 1, wherein the gasket spacer and the anti extrusion ring are made of a forged grade metal.

14. The apparatus according to claim 1, wherein the anti extrusion rings prevent the gaskets from extruding underneath the mating gasket spacer rings.
